(19) United States
(12) Patent Application Publication
(10) Pub. No.: US 2017/0155667 A1
(43) Pub. Date: Jun. 1, 2017

(54) SYSTEMS AND METHODS FOR DETECTING MALWARE INFECTIONS VIA DOMAIN NAME SERVICE TRAFFIC ANALYSIS

(71) Applicant: Symantec Corporation, Mountain View, CA (US)

(72) Inventor: William E. Sobel, Jamul, CA (US)

(21) Appl. No.: 14/954,425

(22) Filed: Nov. 30, 2015

(51) Int. Cl. H04L 29/06

(52) U.S. Cl. CPC H04L 63/1416; H04L 63/145

(57) ABSTRACT

The disclosed computer-implemented method for detecting malware infections via domain name service traffic analysis may include (1) detecting, on the computing device, a failed domain name service request originating from the computing device, (2) creating a record including information about the failed domain name request and a static unique identifier for the computing device, (3) correlating the record with a set of previous records about failed domain name service requests originating from the computing device with the static unique identifier, and (4) determining, based on correlating the record with the set of previous records, that the computing device is infected with malware that generated the failed domain name service request. Various other methods, systems, and computer-readable media are also disclosed.

### BACKGROUND

Viruses, Trojans, spyware, and other kinds of malware are a constant threat to any computing device that requires network connectivity. Many different types of security systems exist to combat these threats, ranging from browser plug-ins to virus scanners to firewalls and beyond. Countless new instances and permutations of malware are created every day, requiring security systems to be constantly updated. Despite this vigilance, computing devices continue to be infected by threats of all types. A piece of malware may bypass several layers of security systems without being detected and may then proceed to contact command-and-control servers to determine what action to take next.

Many traditional systems for remediating malware may attempt to identify or even intercept messages from malware to command-and-control servers. This has caused malware creators to find ever more creative means of hiding the communication between malicious applications and servers. One solution used by attackers is malware that uses domain name service (DNS) lookup requests to find and connect to domains that point to command-and-control services. Some malware may be coded with domain name generation algorithms that enable the malware to connect to constantly-moving command-and-control servers in order to avoid detection by anti-malware systems. Accordingly, the instant disclosure identifies and addresses a need for additional and improved systems and methods for detecting malware infections via DNS traffic analysis.

### SUMMARY

As will be described in greater detail below, the instant disclosure describes various systems and methods for detecting malware infections via DNS traffic analysis by storing records of failed DNS lookups originating from the same computing advice and analyzing the records to determine whether malware is likely to have generated the failed lookups.

In one example, a computer-implemented method for detecting malware infections via DNS traffic analysis may include (1) detecting, on a computing device, a failed DNS request originating from the computing device, (2) creating a record including information about the failed domain name request and a static unique identifier for the computing device, (3) correlating the record with a set of previous records about failed DNS requests originating from the computing device with the static unique identifier, and (4) determining, based on correlating the record with the set of previous records, that the computing device is infected with malware that generated the failed DNS request.

In one embodiment, creating the record may include sending a message from the computing device to a network-level analysis system and correlating the record with the set of previous records may include, correlating by the network-level analysis system, the message with a set of previous messages sent by the computing device with the static unique identifier. In this embodiment, determining that the computing device is infected with malware may include determining, by the network-level analysis system, that the computing device is infected with malware.

In one example, the set of previous records about failed DNS requests originating from the computing device with the static unique identifier may include records of failed DNS requests originating from the computing device with the static unique identifier on a group of different networks. In some examples, determining that the computing device is infected with the malware may include determining that the computing device with the static unique identifier has generated a percentage of failed DNS requests that exceeds a predetermined threshold for benign percentages of failed DNS requests. In one embodiment, the predetermined threshold for benign percentages of failed DNS requests may include a statistical norm of failed DNS requests across a group of computing devices.

In some examples, the computer-implemented method may further include performing a malware remediation action on the computing device with the static unique identifier based on determining that the computing device is infected with the malware. In one embodiment, the static unique identifier may include an identifier that is not assigned to the computing device by a network and that can only be changed by an administrator.

In one embodiment, a system for implementing the above-described method may include (1) a detection module, stored in memory, that detects, on the computing device, a failed DNS request originating from the computing device, (2) a creation module, stored in memory, that creates a record including information about the failed domain name request and a static unique identifier for the computing device, (3) a correlation module, stored in memory, that correlates the record with a set of previous records about failed DNS requests originating from the computing device with the static unique identifier, (4) a determination module, stored in memory, that determines, based on correlating the record with the set of previous records, that the computing device is infected with malware that generated the failed DNS request, and (5) at least one physical processor configured to execute the detection module, the creation module, the correlation module, and the determination module.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (1) detect, on the computing device, a failed DNS request originating from the computing device, (2) create a record including information about the failed domain name request and a static unique identifier for the computing device, (3) correlate the record with a set of previous records about failed DNS requests originating from the computing device with the static unique identifier, and (4) determine, based on correlating the record with the set of previous records, that the computing device is infected with malware that generated the failed DNS request.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for detecting malware infections via domain name service traffic analysis.

FIG. 2 is a block diagram of an additional exemplary system for detecting malware infections via domain name service traffic analysis.

FIG. 3 is a flow diagram of an exemplary method for detecting malware infections via domain name service traffic analysis.

FIG. 4 is a block diagram of exemplary failed DNS lookup records.

FIG. 5 is a block diagram of an exemplary computing system for detecting malware infections via domain name service traffic analysis.

FIG. 6 is a block diagram of an exemplary computing system capable of implementing one or more of the embodiments described and/or illustrated herein.

FIG. 7 is a block diagram of an exemplary computing network capable of implementing one or more of the embodiments described and/or illustrated herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for detecting malware infections via domain name service traffic analysis. As will be explained in greater detail below, by correlating failed DNS requests using a static unique identifier for a computing device, failed requests can be tracked across networks and can also be tracked when the computing device's Internet Protocol (IP) address changes. Correlating failed DNS requests in this way allows the systems and methods described herein to more effectively identify computing devices infected with malware.

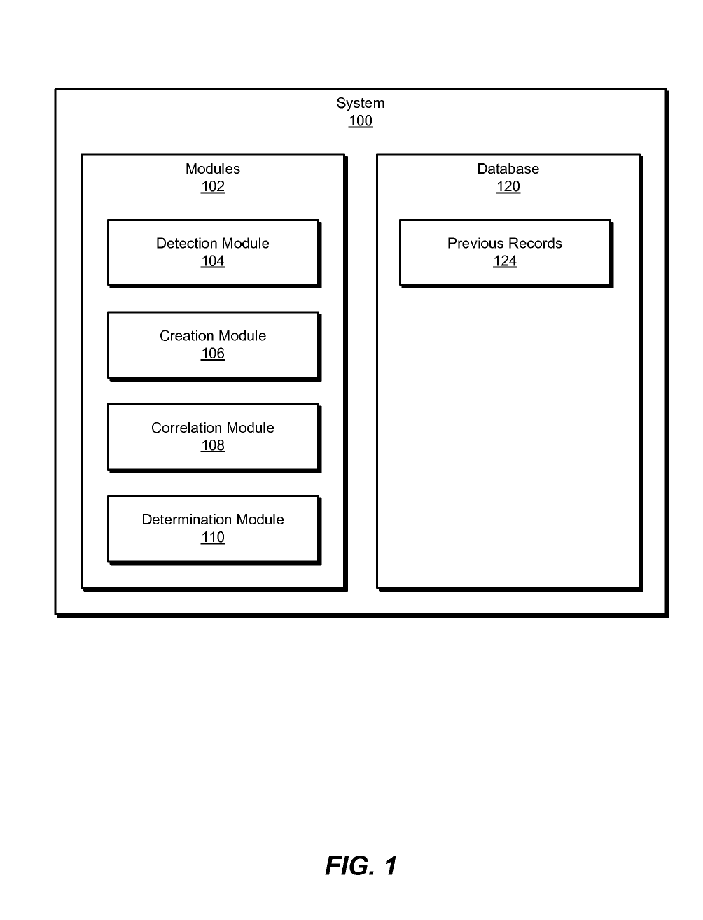

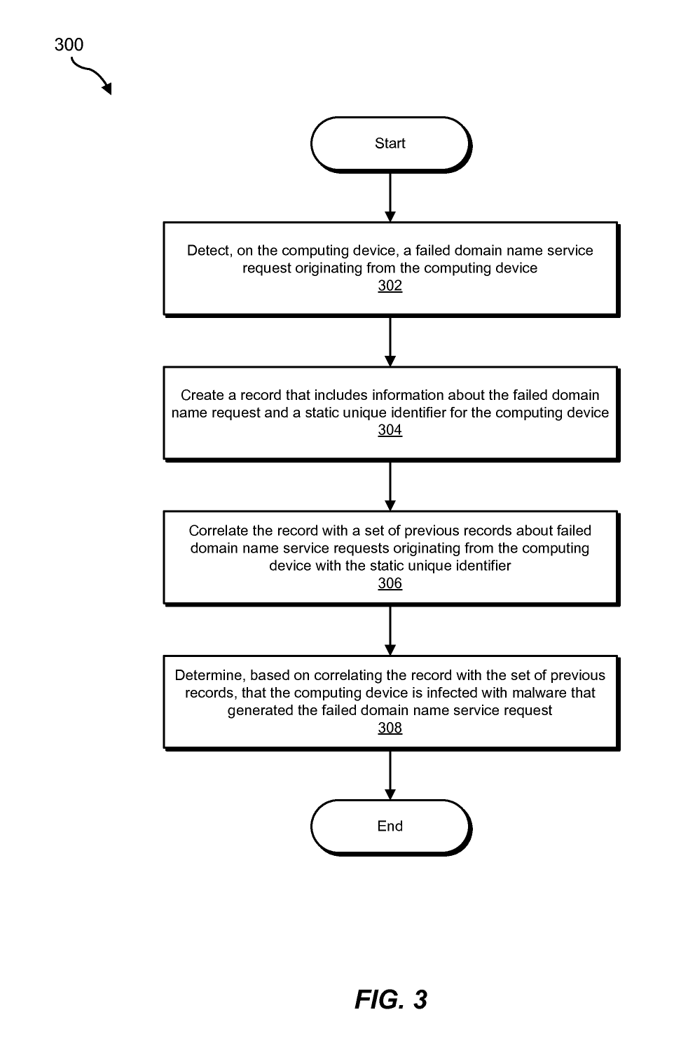

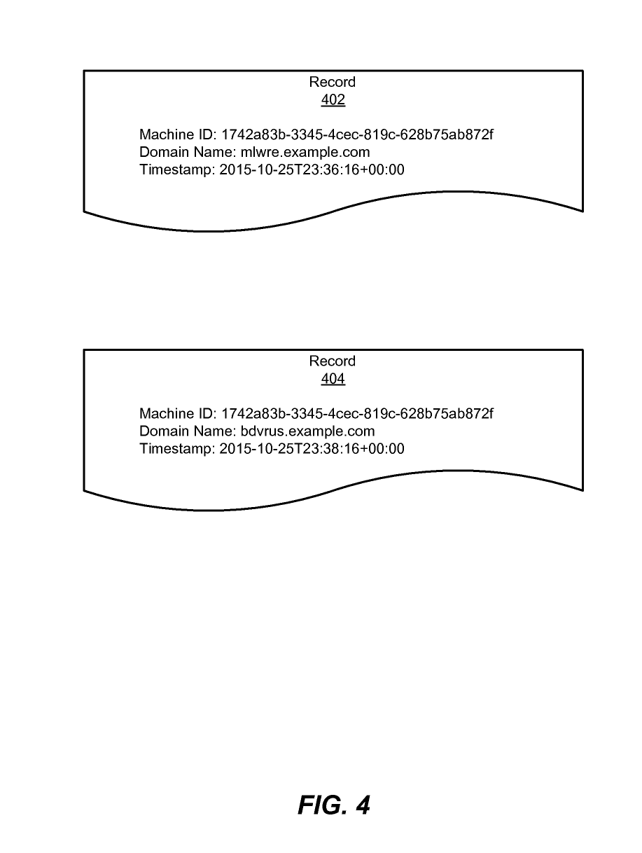

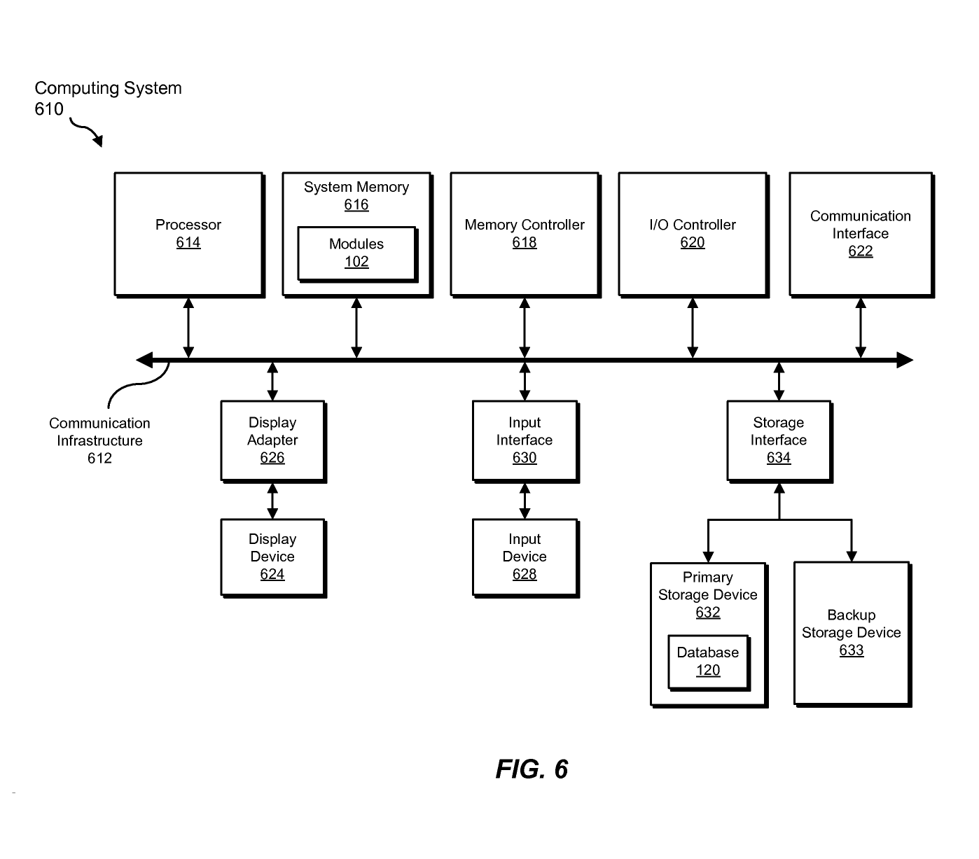

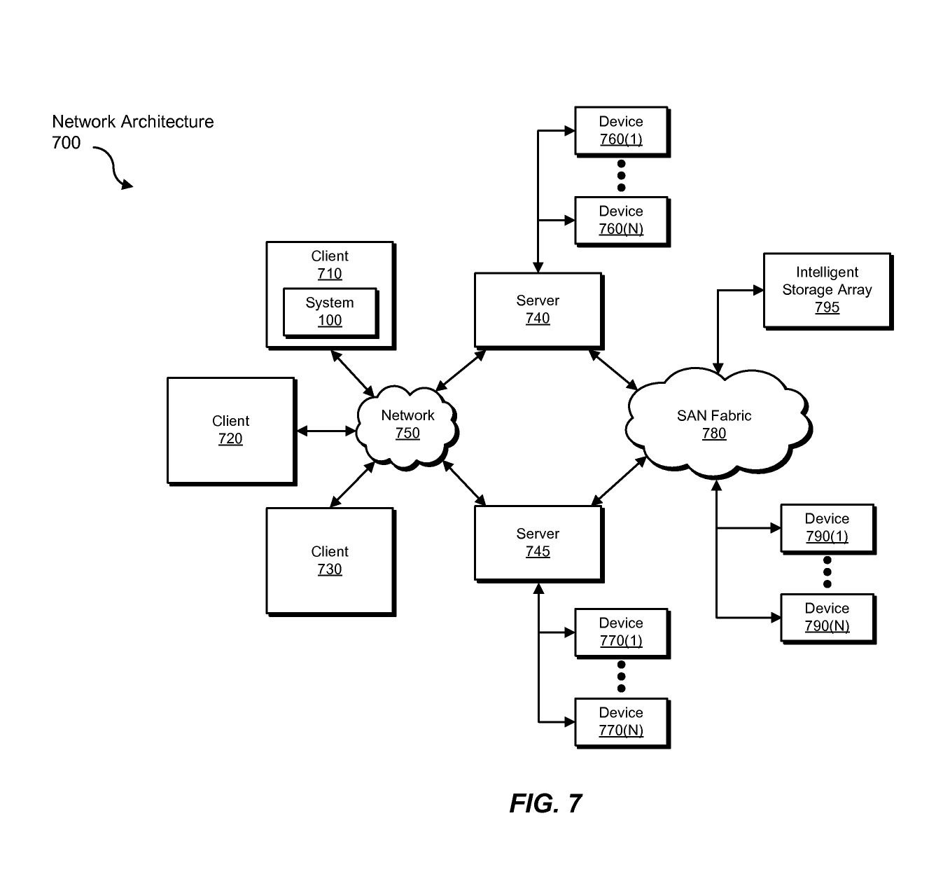

The following will provide, with reference to FIGS. 1, 2, and 5, detailed descriptions of exemplary systems for detecting malware infections via domain name service traffic analysis. Detailed descriptions of corresponding computer-implemented methods will also be provided in connection with FIG. 3. Detailed descriptions of corresponding exemplary failed DNS lookup records will be provided in combination with FIG. 4. In addition, detailed descriptions of an exemplary computing system and network architecture capable of implementing one or more of the embodiments described herein will be provided in connection with FIGS. 6 and 7, respectively.

FIG. 1 is a block diagram of exemplary system 100 for detecting malware infections via DNS traffic analysis. As illustrated in this figure, exemplary system 100 may include one or more modules 102 for performing one or more tasks. For example, and as will be explained in greater detail below, exemplary system 100 may include a detection module 104 that detects, on the computing device, a failed DNS request originating from the computing device. Exemplary system 100 may additionally include a creation module 106 that creates a record that includes information about the failed domain name request and a static unique identifier for the computing device. Exemplary system 100 may also include a correlation module 108 that correlates the record with a set of previous records about failed DNS requests originating from the computing device with the static unique identifier. Exemplary system 100 may additionally include a determination module 110 that determines, based on correlating the record with the set of previous records, that the computing device is infected with malware that generated the failed DNS request. Although illustrated as separate elements, one or more of modules 102 in FIG. 1 may represent portions of a single module or application.

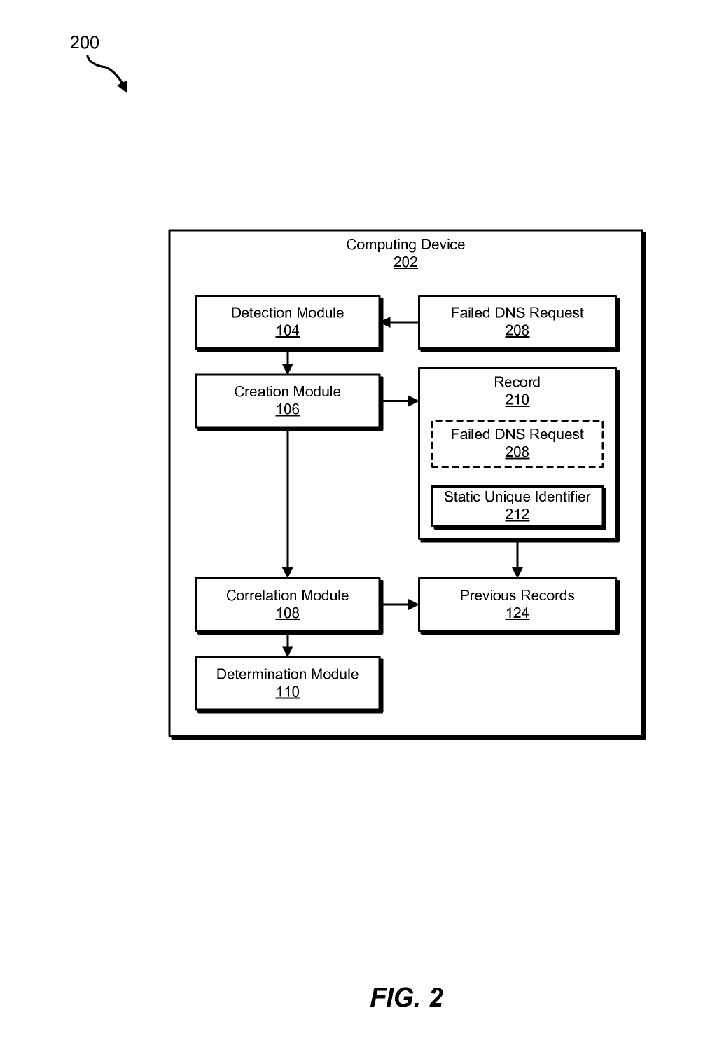

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent software modules stored and configured to run on one or more computing devices, such as computing device 202 in FIG. 2, computing system 610 in FIG. 6, and/or portions of exemplary network architecture 700 in FIG. 7. One or more of modules 102 in FIG. 1 may also represent all or portions of one or more special-purpose computers configured to perform one or more tasks.

As illustrated in FIG. 1, exemplary system 100 may also include one or more databases, such as database 120. In one example, database 120 may be configured to store previous records of failed DNS requests, such as previous records 124.

Database 120 may represent portions of a single database or computing device or a plurality of databases or computing devices. For example, database 120 may represent a portion of server 206 in FIG. 2, computing system 610 in FIG. 6, and/or portions of exemplary network architecture 700 in FIG. 7. Alternatively, database 120 in FIG. 1 may represent one or more physically separate devices capable of being accessed by a computing device, such as computing system 610 in FIG. 6 and/or portions of exemplary network architecture 700 in FIG. 7.

Exemplary system 100 in FIG. 1 may be implemented in a variety of ways. For example, all or a portion of exemplary system 100 may represent portions of exemplary system 200 in FIG. 2. As shown in FIG. 2, system 200 may include a computing device 202. In one example, computing device 202 may be programmed with one or more of modules 102 and/or may store all or a portion of the data in database 120.

In one embodiment, one or more of modules 102 from FIG. 1 may, when executed by at least one processor of computing device 202, enable computing device 202 to detect malware infections via DNS traffic analysis. For example, and as will be described in greater detail below, detection module 104 may detect, on computing device 202, a failed DNS request 208 originating from computing device 202. Next, creation module 106 may create a record 210 comprising information about the failed domain name request and a static unique identifier 212 for computing device 202. Either immediately afterwards or at some later time, correlation module 108 may correlate record 210 with a previous records 124 about failed DNS requests originating from computing device 202 with static unique identifier 212. Finally, determination module 110 may determine, based on correlating record 210 with previous records 124, that computing device 202 is infected with malware that generated the failed DNS request 208.

Computing device 202 generally represents any type or form of computing device capable of reading computer-executable instructions. Examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), gaming consoles, combinations of one or more of the same, exemplary computing system 610 in FIG. 6, or any other suitable computing device.

FIG. 3 is a flow diagram of an exemplary computer-implemented method 300 for detecting malware infections via domain name service traffic analysis. The steps shown in FIG. 3 may be performed by any suitable computer-executable code and/or computing system. In some embodiments, the steps shown in FIG. 3 may be performed by one or more of the components of system 100 in FIG. 1, system 200 in FIG. 2, computing system 610 in FIG. 6, and/or portions of exemplary network architecture 700 in FIG. 7.

As illustrated in FIG. 3, at step 302, one or more of the systems described herein may detect, on the computing device, a failed DNS request originating from the computing device. For example, detection module 104 may, as part of computing device 202 in FIG. 2, detect, on computing device 202, a failed DNS request 208 originating from computing device 202.

The term “domain name service request” or “DNS request,” as used herein, generally refers to any request sent to a centralized service in an attempt to connect to a server. For example, a DNS request may be a request sent to a DNS service to translate a domain name into an IP address. The term “failed DNS request,” as used herein, generally refers to any DNS request that fails to return a valid IP address that points to a legitimate web page. For example, a failed DNS request may be a request for a domain name that does not resolve to an IP address. In some examples, a failed request may result when a DNS request is made for a domain name that is not registered. In another example, a DNS service may return a default web page (e.g., an advertising page) in response to all requests for unregistered domains. In some examples, a piece of malware may use a domain generation algorithm to programmatically generate a large number of domain names, only a portion of which may point to valid IP addresses of malware command-and-control servers.

Detection module 104 may detect the failed DNS request 208 in a variety of contexts. For example, detection module 104 may monitor all outgoing DNS requests and/or all incoming responses to DNS requests. In one embodiment, detection module 104 may be part of a firewall that filters and/or monitors network traffic. In another embodiment, detection module 104 may be part of a security application that examines network traffic. In some examples, detection module 104 may detect a failed DNS request by receiving a response that includes a potential DNS-service-generated default web page, sending an additional request for a known unregistered domain name, receiving the same web page in response to the additional request, and determining that the initial DNS request was a failed request based on receiving a default web page in response to both requests.

At step 304, one or more of the systems described herein may create a record including information about the failed domain name request and a static unique identifier for the computing device. For example, creation module 106 may, as part of computing device 202 in FIG. 2, create record 210 including information about the failed domain name request and static unique identifier 212 for computing device 202.

The term “static unique identifier,” as used herein, generally refers to any identifier that uniquely describes a computing device, does not change when the computing device changes networks, and/or is not subject to non-manual changes. In some embodiments, a static unique identifier may only uniquely differentiate a computing device from other computing devices in a group and/or on a network. For example, a computing device may be identified with a name such as “accounting desktop 03,” “User laptop,” and/or “Serenity” that may be a unique identifier among computing devices administered by an organization but that may not be a globally unique identifier across all computing devices. In other embodiments, a static unique identifier may include a globally unique identifier (GUID). In one embodiment, the static unique identifier may include an identifier that is not assigned to the computing device by a network and that can only be changed by an administrator. In contrast, an IP address is not a static unique identifier because an IP address may change automatically without administrator intervention and/or may change when the computing devices switches networks.

The term “record,” as used herein, generally refers to any stored information about a failed DNS request and a static unique identifier for the computing device that originated the request. As illustrated in FIG. 4, in some embodiments, a record may include a machine identifier for the computing device, a domain name that was requested, and/or a timestamp of the request. For example, records 402 and 404 may record failed DNS requests for different times and different domains originating from a computing device with the same machine identifier. Additionally or alternatively, a record may store information about a network that the computing device was connected to when the failed DNS request occurred, a latency of the failed DNS request, an application that generated the failed DNS request, and/or any other information about the failed DNS request.

In some embodiments, a record may include a message sent from the computing device to another device and/or system. For example, a computing device may send information about failed DNS requests to a DNS traffic analysis system that analyzes DNS traffic for a network. In some embodiments, an anti-malware application on the computing device may send information about failed DNS requests to a backend anti-malware system located on a server.

Creation module 106 may create the record in a variety of ways. For example, creation module 106 may create the record and then store the record locally in a database. In another example, creation module 106 may send a message including the record instead of, or in addition to, storing the record locally.

Returning to FIG. 3, at step 306, one or more of the systems described herein may correlate the record with a set of previous records about failed DNS requests originating from the computing device with the static unique identifier. For example, correlation module 108 may, as part of computing device 202 in FIG. 2, correlate record 210 with a previous records 124 about failed DNS requests originating from computing device 202 with static unique identifier 212.

Correlation module 108 may correlate the records in a variety of contexts. For example, correlation module 108 may correlate the new record with other locally stored records on the computing device. In another embodiment, correlation module 108 may be hosted on an additional computing device and may correlate the new record with other records stored remotely.

In one embodiment, the set of previous records about failed DNS requests originating from the computing device with the static unique identifier may include records of failed DNS requests originating from the computing device with the static unique identifier on a plurality of different networks. For example, a correlation module 108 may correlate a record of a failed DNS request sent while the computing device is connected to a wireless network at a coffee shop with records of previous failed DNS requests made from a home network and/or an office network.

At step 308, one or more of the systems described herein may determine, based on correlating the record with the set of previous records, that the computing device is infected with malware that generated the failed DNS request. For example, determination module 110 may, as part of computing device 202 in FIG. 2, determine, based on correlating record 210 with previous records 124, that computing device 202 is infected with malware that generated the failed DNS request.

The term “malware,” as used herein, generally refers to any unwanted file, script, and/or application on a computing device. In some embodiments, malware may perform malicious actions including but not limited to deleting files, encrypting files, stealing personal information, and/or recording actions. Examples of malware may include, without limitation, Trojans, spyware, adware, and/or viruses.

Determination module 110 may determine that the computing device is infected with malware in a variety of ways. For example, determination module 110 may determine that the computing device is infected with malware by determining that the computing device has generated a percentage of failed DNS requests that exceeds a predetermined threshold for benign percentages of failed DNS requests.

For example, the computing device may have a failure rate of 80% for DNS requests, indicating that some application is generating requests for a large number of invalid domain names. In one embodiment, the predetermined threshold for benign percentages of failed DNS requests may include a statistical norm of failed DNS requests across a group of computing devices. For example, the average percentage of failed DNS requests across computing devices administered by an organization may be 10%, and the threshold may be 20%. In another example, the average percentage of failed DNS requests for all computing devices on a network may be 5% and the threshold may be 7%. In some examples, determination module 110 may determine that the computing device has exceeded the benign percentage threshold over a predetermined period of time. For example, determination module 110 may analyze DNS traffic data from an hour, a day, and/or a week and determine the percentage of failed DNS requests generated by the computing device within that time span.

In another embodiment, determination module 110 may determine that a computing device is infected with malware if the computing device exceeds a threshold for a number of failed domain requests within a certain timespan. For example, determination module 110 may determine that a computing device that generates 500 failed DNS requests with one minute is infected with malware. In another example, determination module 110 may determine that a computing device that generates 3000 failed DNS requests within an hour is infected with malware.

Additionally or alternatively, determination module 110 may determine that the computing device is infected with malware by also analyzing DNS requests from other computing devices. For example, determination module 110 may determine that the computing device has generated DNS requests to domain names that match failed DNS requests from other computing devices, and thus all of the computing devices are likely infected with malware. In some embodiments, determination module 110 may use information received from the computing device to generate blacklists of suspicious domain names to be used by other computing devices.

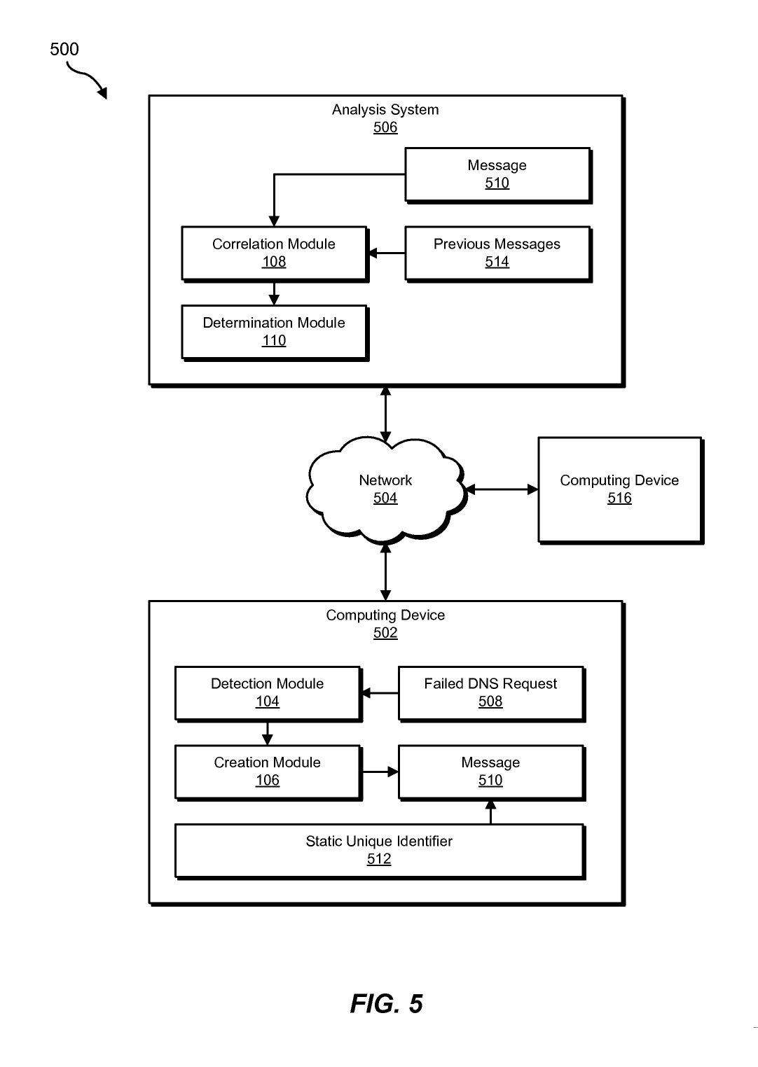

In one embodiment, determination module 110 may be part of a network-level analysis system, along with correlation module 108 and/or a database storing previous records. As illustrated in FIG. 5, a computing device 502 may communicate with an analysis system 506 via a network 504. Analysis system 506 may represent any type of DNS traffic and/or malware analysis system hosted on any type of computing device. In some embodiments, analysis system 506 may be hosted on a security server, router, and/or network switch. In one example, detection module 104 may detect a failed DNS request 508 generated by computing device 502. Correlation module 108 may then create a message 510 that includes information about failed DNS request 508 as well as a unique static identifier 512 for computing device 502.

In this example, correlation module 108 may receive message 510 on analysis system 506 and/or may correlate information in message 510 with previous messages 514. Determination module 110 may then analyze message in combination with previous messages 514 in order to determine whether failed DNS request 508 was generated by malware.

In some examples, the systems described herein may perform a malware remediation action on the computing device based on determining that the computing device is infected with the malware. In some embodiments, the systems described herein may direct a user to run malware cleanup tools. In other embodiments, an administrator may remotely run an anti-malware utility on the computing device. In some embodiments, the systems described herein may execute and/or prompt a user to execute an aggressive anti-malware tool (e.g., NORTON POWER ERASER, MALWAREBYTES ANTI-MALWARE, and/or COMODO CLEANING ESSENTIALS) due to the malware being undetected by the currently running anti-malware applications.

In some embodiments, the systems described herein may be implemented as two web based systems, one for submission of the DNS requests information as well as a second web based system that could be queried by a computing device or a manager of computing devices to ask if itself or any machines under its management domain appear infected. The unique static identifier may be used as the query parameter, and in some examples this may trigger a workflow for an end user to run more aggressive anti-malware and cleanup tools. Additionally or alternatively, the manager may query in single unit or bulk if any of the computing devices under its management are infected and/or trigger administrative work flows (that may include some or all of the end user workflow) to trigger the aggressive anti-malware and/or cleanup tools.

As explained in connection with method 300 above, the systems and methods described herein may detect previously undetected malware on computing devices by analyzing DNS traffic. In some embodiments, the systems described herein may send information about failed DNS requests to a network-level analysis system that may analyze failed DNS requests for multiple computing devices connected to the network. In these embodiments, the systems described herein may include a static unique identifier for the computing device in the reports of the failed DNS requests so that information from the same computing device can be correlated even if the IP address of the computing device changes or the failed DNS requests occurred when the computing device was connected to a different network.

FIG. 6 is a block diagram of an exemplary computing system 610 capable of implementing one or more of the embodiments described and/or illustrated herein. For example, all or a portion of computing system 610 may perform and/or be a means for performing, either alone or in combination with other elements, one or more of the steps described herein (such as one or more of the steps illustrated in FIG. 3). All or a portion of computing system 610 may also perform and/or be a means for performing any other steps, methods, or processes described and/or illustrated herein.

Computing system 610 broadly represents any single or multi-processor computing device or system capable of executing computer-readable instructions. Examples of computing system 610 include, without limitation, workstations, laptops, client-side terminals, servers, distributed computing systems, handheld devices, or any other computing system or device. In its most basic configuration, computing system 610 may include at least one processor 614 and a system memory 616.

Processor 614 generally represents any type or form of physical processing unit (e.g., a hardware-implemented central processing unit) capable of processing data or interpreting and executing instructions. In certain embodiments, processor 614 may receive instructions from a software application or module. These instructions may cause processor 614 to perform the functions of one or more of the exemplary embodiments described and/or illustrated herein.

System memory 616 generally represents any type or form of volatile or non-volatile storage device or medium capable of storing data and/or other computer-readable instructions. Examples of system memory 616 include, without limitation, Random Access Memory (RAM), Read Only Memory (ROM), flash memory, or any other suitable memory device. Although not required, in certain embodiments computing system 610 may include both a volatile memory unit (such as, for example, system memory 616) and a non-volatile storage device (such as, for example, primary storage device 632, as described in detail below). In one example, one or more of modules 102 from FIG. 1 may be loaded into system memory 616.

In certain embodiments, exemplary computing system 610 may also include one or more components or elements in addition to processor 614 and system memory 616. For example, as illustrated in FIG. 6, computing system 610 may include a memory controller 618, an Input/Output (I/O) controller 620, and a communication interface 622, each of which may be interconnected via a communication infrastructure 612. Communication infrastructure 612 generally represents any type or form of infrastructure capable of facilitating communication between one or more components of a computing device. Examples of communication infrastructure 612 include, without limitation, a communication bus (such as an Industry Standard Architecture (ISA), Peripheral Component Interconnect (PCI), PCI Express (PCIe), or similar bus) and a network.

Memory controller 618 generally represents any type or form of device capable of handling memory or data or controlling communication between one or more components of computing system 610. For example, in certain embodiments memory controller 618 may control communication between processor 614, system memory 616, and I/O controller 620 via communication infrastructure 612.

I/O controller 620 generally represents any type or form of module capable of coordinating and/or controlling the input and output functions of a computing device. For example, in certain embodiments I/O controller 620 may control or facilitate transfer of data between one or more elements of computing system 610, such as processor 614, system memory 616, communication interface 622, display adapter 626, input interface 630, and storage interface 634.

Communication interface 622 broadly represents any type or form of communication device or adapter capable of facilitating communication between exemplary computing system 610 and one or more additional devices. For example, in certain embodiments communication interface 622 may facilitate communication between computing system 610 and a private or public network including additional computing systems. Examples of communication interface 622 include, without limitation, a wired network interface (such as a network interface card), a wireless network interface (such as a wireless network interface card), a modem, and any other suitable interface. In at least one embodiment, communication interface 622 may provide a direct connection to a remote server via a direct link to a network, such as the Internet. Communication interface 622 may also indirectly provide such a connection through, for example, a local area network (such as an Ethernet network), a personal area network, a telephone or cable network, a cellular telephone connection, a satellite data connection, or any other suitable connection.

In certain embodiments, communication interface 622 may also represent a host adapter configured to facilitate communication between computing system 610 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 622 may also allow computing system 610 to engage in distributed or remote computing. For example, communication interface 622 may receive instructions from a remote device or send instructions to a remote device for execution.

As illustrated in FIG. 6, computing system 610 may also include at least one display device 624 coupled to communication infrastructure 612 via a display adapter 626. Display device 624 generally represents any type or form of device capable of visually displaying information forwarded by display adapter 626. Similarly, display adapter 626 generally represents any type or form of device configured to forward graphics, text, and other data from communication infrastructure 612 (or from a frame buffer, as known in the art) for display on display device 624.

As illustrated in FIG. 6, exemplary computing system 610 may also include at least one input device 628 coupled to communication infrastructure 612 via an input interface 630. Input device 628 generally represents any type or form of input device capable of providing input, either computer or human generated, to exemplary computing system 610. Examples of input device 628 include, without limitation, a keyboard, a pointing device, a speech recognition device, or any other input device.

As illustrated in FIG. 6, exemplary computing system 610 may also include a primary storage device 632 and a backup storage device 633 coupled to communication infrastructure 612 via a storage interface 634. Storage devices 632 and 633 generally represent any type or form of storage device or medium capable of storing data and/or other computer-readable instructions. For example, storage devices 632 and 633 may be a magnetic disk drive (e.g., a so-called hard drive), a solid state drive, a floppy disk drive, a magnetic tape drive, an optical disk drive, a flash drive, or the like. Storage interface 634 generally represents any type or form of interface or device for transferring data between storage devices 632 and 633 and other components of computing system 610. In one example, database 120 from FIG. 1 may be stored in primary storage device 632.

In certain embodiments, storage devices 632 and 633 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 632 and 633 may also include other similar structures or devices for allowing computer software, data, or other computer-readable instructions to be loaded into computing system 610. For example, storage devices 632 and 633 may be configured to read and write software, data, or other computer-readable information. Storage devices 632 and 633 may also be a part of computing system 610 or may be a separate device accessed through other interface systems.

Many other devices or subsystems may be connected to computing system 610. Conversely, all of the components and devices illustrated in FIG. 6 need not be present to practice the embodiments described and/or illustrated herein. The devices and subsystems referenced above may also be interconnected in different ways from that shown in FIG. 6. Computing system 610 may also employ any number of software, firmware, and/or hardware configurations. For example, one or more of the exemplary embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 610. All or a portion of the computer program stored on the computer-readable medium may then be stored in system memory 616 and/or various portions of storage devices 632 and 633. When executed by processor 614, a computer program loaded into computing system 610 may cause processor 614 to perform and/or be a means for performing the functions of one or more of the exemplary embodiments described and/or illustrated herein. Additionally or alternatively, one or more of the exemplary embodiments described and/or illustrated herein may be implemented in firmware and/or hardware. For example, computing system 610 may be configured as an Application Specific Integrated Circuit (ASIC) adapted to implement one or more of the exemplary embodiments disclosed herein.

FIG. 7 is a block diagram of an exemplary network architecture 700 in which client systems 710, 720, and 730 and servers 740 and 745 may be coupled to a network 750. As detailed above, all or a portion of network architecture 700 may perform and/or be a means for performing, either alone or in combination with other elements, one or more of the steps disclosed herein (such as one or more of the steps illustrated in FIG. 3). All or a portion of network architecture 700 may also be used to perform and/or be a means for performing other steps and features set forth in the instant disclosure.

Client systems 710, 720, and 730 generally represent any type or form of computing device or system, such as exemplary computing system 610 in FIG. 6. Similarly, servers 740 and 745 generally represent computing devices or systems, such as application servers or database servers, configured to provide various database services and/or run certain software applications. Network 750 generally represents any telecommunication or computer network including, for example, an intranet, a WAN, a LAN, a PAN, or the Internet. In one example, client systems 710, 720, and/or 730 and/or servers 740 and/or 745 may include all or a portion of system 100 from FIG. 1.

As illustrated in FIG. 7, one or more storage devices 760(1)-(N) may be directly attached to server 740. Similarly, one or more storage devices 770(1)-(N) may be directly attached to server 745. Storage devices 760(1)-(N) and storage devices 770(1)-(N) generally represent any type or form of storage device or medium capable of storing data and/or other computer-readable instructions. In certain embodiments, storage devices 760(1)-(N) and storage devices 770(1)-(N) may represent Network-Attached Storage (NAS) devices configured to communicate with servers 740 and 745 using various protocols, such as Network File System (NFS), Server Message Block (SMB), or Common Internet File System (CIFS).

Servers 740 and 745 may also be connected to a Storage Area Network (SAN) fabric 780. SAN fabric 780 generally represents any type or form of computer network or architecture capable of facilitating communication between a plurality of storage devices. SAN fabric 780 may facilitate communication between servers 740 and 745 and a plurality of storage devices 790(1)-(N) and/or an intelligent storage array 795. SAN fabric 780 may also facilitate, via network 750 and servers 740 and 745, communication between client systems 710, 720, and 730 and storage devices 790(1)-(N) and/or intelligent storage array 795 in such a manner that devices 790(1)-(N) and array 795 appear as locally attached devices to client systems 710, 720, and 730. As with storage devices 760(1)-(N) and storage devices 770(1)-(N), storage devices 790(1)-(N) and intelligent storage array 795 generally represent any type or form of storage device or medium capable of storing data and/or other computer-readable instructions.

In certain embodiments, and with reference to exemplary computing system 610 of FIG. 6, a communication interface, such as communication interface 622 in FIG. 6, may be used to provide connectivity between each client system 710, 720, and 730 and network 750. Client systems 710, 720, and 730 may be able to access information on server 740 or 745 using, for example, a web browser or other client software. Such software may allow client systems 710, 720, and 730 to access data hosted by server 740, server 745, storage devices 760(1)-(N), storage devices 770(1)-(N), storage devices 790(1)-(N), or intelligent storage array 795. Although FIG. 7 depicts the use of a network (such as the Internet) for exchanging data, the embodiments described and/or illustrated herein are not limited to the Internet or any particular network-based environment.

In at least one embodiment, all or a portion of one or more of the exemplary embodiments disclosed herein may be encoded as a computer program and loaded onto and executed by server 740, server 745, storage devices 760(1)-(N), storage devices 770(1)-(N), storage devices 790(1)-(N), intelligent storage array 795, or any combination thereof. All or a portion of one or more of the exemplary embodiments disclosed herein may also be encoded as a computer program, stored in server 740, run by server 745, and distributed to client systems 710, 720, and 730 over network 750.

As detailed above, computing system 610 and/or one or more components of network architecture 700 may perform and/or be a means for performing, either alone or in combination with other elements, one or more steps of an exemplary method for detecting malware infections via domain name service traffic analysis.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

In some examples, all or a portion of exemplary system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of exemplary system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of exemplary system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of exemplary system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of exemplary system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of exemplary system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of exemplary system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

While various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

In addition, one or more of the modules described herein may transform data, physical devices, and/or representations of physical devices from one form to another. For example, one or more of the modules recited herein may receive DNS request data to be transformed, transform the DNS request data into a record, output a result of the transformation to a correlation module, use the result of the transformation to determine if malware generated one or more DNS requests, and store the result of the transformation to a database. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for detecting malware infections via domain name service traffic analysis, at least a portion of the method being performed by a computing device comprising at least one processor, the method comprising:
detecting, on the computing device, a failed domain name service request originating from the computing device;
creating a record comprising information about the failed domain name request and a static unique identifier for the computing device;
correlating the record with a set of previous records about failed domain name service requests originating from the computing device with the static unique identifier;
determining, based on correlating the record with the set of previous records, that the computing device is infected with malware that generated the failed domain name service request.

2. The computer-implemented method of claim 1, wherein:
creating the record comprises sending a message from the computing device to a network-level analysis system;
correlating the record with the set of previous records comprises correlating, by the network-level analysis system, the message with a set of previous messages sent by the computing device with the static unique identifier;
determining that the computing device is infected with the malware comprises determining, by the network-level analysis system, that the computing device is infected with malware.

3. The computer-implemented method of claim 1, wherein the set of previous records about failed domain name service requests originating from the computing device with the static unique identifier comprises records of failed domain name service requests originating from the computing device with the static unique identifier on a plurality of different networks.

4. The computer-implemented method of claim 1, wherein determining that the computing device is infected with the malware comprises determining that the computing device with the static unique identifier has generated a percentage of failed domain name service requests that exceeds a predetermined threshold for benign percentages of failed domain name service requests.

5. The computer-implemented method of claim 4, wherein the predetermined threshold for benign percentages of failed domain name service requests comprises a statistical norm of failed domain name service requests across a plurality of computing devices.

6. The computer-implemented method of claim 1, further comprising performing a malware remediation action on the computing device with the static unique identifier based on determining that the computing device is infected with the malware.

7. The computer-implemented method of claim 1, wherein the static unique identifier comprises an identifier that is not assigned to the computing device by a network and that can only be changed by an administrator.

8. A system for detecting malware infections via domain name service traffic analysis, the system comprising:
a detection module, stored in memory, that detects, on the computing device, a failed domain name service request originating from the computing device;
a creation module, stored in memory, that creates a record comprising information about the failed domain name request and a static unique identifier for the computing device;
a correlation module, stored in memory, that correlates the record with a set of previous records about failed domain name service requests originating from the computing device with the static unique identifier;
a determination module, stored in memory, that determines, based on correlating the record with the set of previous records, that the computing device is infected with malware that generated the failed domain name service request;
at least one physical processor configured to execute the detection module, the creation module, the correlation module, and the determination module.

9. The system of claim 8, wherein:
the creation module creates the record by sending a message from the computing device to a network-level analysis system;
the correlation module correlates the record with the set of previous records by correlating, by the network-level analysis system, the message with a set of previous messages sent by the computing device with the static unique identifier;
the determination module determines that the computing device is infected with the malware by determining, by the network-level analysis system, that the computing device is infected with malware.

10. The system of claim 8, wherein the set of previous records about failed domain name service requests originating from the computing device with the static unique identifier comprises records of failed domain name service requests originating from the computing device with the static unique identifier on a plurality of different networks.

11. The system of claim 8, wherein the determination module determines that the computing device is infected with the malware by determining that the computing device with the static unique identifier has generated a percentage of failed domain name service requests that exceeds a predetermined threshold for benign percentages of failed domain name service requests.

12. The system of claim 11, wherein the predetermined threshold for benign percentages of failed domain name service requests comprises a statistical norm of failed domain name service requests across a plurality of computing devices.

13. The system of claim 8, further comprising a remediation module, stored in memory, that performs a malware remediation action on the computing device with the static unique identifier based on determining that the computing device is infected with the malware.

14. The system of claim 8, wherein the static unique identifier comprises an identifier that is not assigned to the computing device by a network and that can only be changed by an administrator.

15. A non-transitory computer-readable medium comprising one or more computer-readable instructions that, when executed by at least one processor of a computing device, cause the computing device to:
detect, on the computing device, a failed domain name service request originating from the computing device;
create a record comprising information about the failed domain name request and a static unique identifier for the computing device;
correlate the record with a set of previous records about failed domain name service requests originating from the computing device with the static unique identifier;
determine, based on correlating the record with the set of previous records, that the computing device is infected with malware that generated the failed domain name service request.

16. The non-transitory computer-readable medium of claim 15, wherein the one or more computer-readable instructions cause the computing device to:
create the record by sending a message from the computing device to a network-level analysis system;
correlate the record with the set of previous records by correlating, by the network-level analysis system, the message with a set of previous messages sent by the computing device with the static unique identifier;
determine that the computing device is infected with the malware by determining, by the network-level analysis system, that the computing device is infected with malware.

17. The non-transitory computer-readable medium of claim 15, wherein the set of previous records about failed domain name service requests originating from the computing device with the static unique identifier comprises records of failed domain name service requests originating from the computing device with the static unique identifier on a plurality of different networks.

18. The non-transitory computer-readable medium of claim 15, wherein the one or more computer-readable instructions cause the computing device to determine that the computing device is infected with the malware by determining that the computing device with the static unique identifier has generated a percentage of failed domain name service requests that exceeds a predetermined threshold for benign percentages of failed domain name service requests.

19. The non-transitory computer-readable medium of claim 18, wherein the predetermined threshold for benign percentages of failed domain name service requests comprises a statistical norm of failed domain name service requests across a plurality of computing devices.

20. The non-transitory computer-readable medium of claim 15, wherein the one or more computer-readable instructions cause the computing device to perform a malware remediation action on the computing device with the static unique identifier based on determining that the computing device is infected with the malware.
